(19) United States
(12) Patent Application Publication
(10) Pub. No.: US 2014/0275308 A1
(43) Pub. Date: Sep. 18, 2014

(54) POLYMER FOAM HAVING AN ELEVATED MAXIMUM SERVICE TEMPERATURE

(71) Applicant: Owens Corning Intellectual Capital, LLC, Toledo, OH (US)

(72) Inventors: Nikoi Annan, Newark, OH (US); Gary Milosovich, Pataskala, OH (US); Yadollah Delaviz, Lewis Center, OH (US); Xiangmin Han, Stow, OH (US)

(73) Assignee: Owens Corning Intellectual Capital, LLC, Toledo, OH (US)

(21) Appl. No.: 14/215,343

(22) Filed: Mar. 17, 2014

Related U.S. Application Data
(60) Provisional application No. 61/789,857, filed on Mar. 15, 2013.

(51) Int. Cl. C08L 25/06; E04D 13/16

(52) U.S. Cl. CPC C08L 25/06; E04D 13/16
USPC 521/139; 521/146; 416/226

(57) ABSTRACT

Polymer foams incorporating fibrous ingredients are disclosed. The fibrous ingredients act as service temperature enhancing agents, increasing the maximum service temperature of the polymer foams as compared to comparable polymer foams that do not incorporate fibrous ingredients. Particularly useful fibrous ingredients include glass fibers and polyaramides having a branched fibrous structure, an example of which is poly para-phenyleneterephthalamide pulp.

### RELATED APPLICATIONS

The present application claims the benefit of U.S. Provisional Patent Application Ser. No. 61/789,857, filed on Mar. 15, 2013, titled “Polymer Foam Having an Elevated Maximum Service Temperature.” U.S. Provisional Patent Application Ser. No. 61/789,857 is incorporated herein by reference in its entirety.

### FIELD

The disclosure is directed to polymeric foam having an elevated maximum service temperature.

### BACKGROUND

Rigid polymeric foams are typically limited to applications that do not exceed a maximum service temperature. For example, rigid, closed cell, extruded polystyrene foam generally has a maximum service temperature ranging from 160 to 180° F., depending on the ingredients and processing of any particular extruded polystyrene foam. At temperatures exceeding the maximum service temperature, the rigid polymeric foam loses dimensional stability and deforms in at least one direction. Certain insulative applications typically requiring a service temperature greater than 160 to 180° F. that would otherwise be ideal for extruded polystyrene foam include under-roof building insulation board and the shear web of a wind blade.

### SUMMARY

In a first exemplary embodiment, the present disclosure is directed to a rigid, closed cell polymeric foam. The rigid, closed cell polymeric foam comprises about 70 to about 96% by weight foamable polymer, about 2 to about 12% by weight of at least one blowing agent, and 0.01 to 10% by weight polyaramid having a branched fibrous structure. The polyaramid having a branched fibrous structure is dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam expands no more than 1% in any direction upon exposure to a temperature of at least about 180° F. for 1 hour.

In a second exemplary embodiment, the present disclosure is directed to a rigid, closed cell polymeric foam insulation board. The rigid, closed cell polymeric foam insulation board comprises about 70 to about 96% by weight polystyrene, about 2 to about 12% by weight of at least one blowing agent, and 0.01 to 10% by weight polyaramid having a branched fibrous structure. The polyaramid having a branched fibrous structure is dispersed throughout the rigid, closed cell polymeric foam insulation board. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam insulation board expands no more than 1% in any direction upon exposure to a temperature of at least about 180° F. for 1 hour.

In a third exemplary embodiment, the present disclosure is directed to a rigid, closed cell polymeric foam. The rigid, closed cell polymeric foam comprises about 60 to about 75% by weight polystyrene, about 2 to about 12% by weight of at least one blowing agent, and about 15 to about 25% by weight glass fibers. The glass fibers are dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam expands no more than 1% in any direction upon exposure to a temperature of at least about 180° F. for 1 hour.

In a fourth exemplary embodiment, the present disclosure is directed to a rigid, closed cell polymeric foam. The rigid, closed cell polymeric foam comprises polystyrene, about 2 to about 12% by weight of at least one blowing agent, and at least one service temperature enhancing agent. The at least one service temperature enhancing agent is dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof. The rigid, closed cell polymeric foam maintains dimensional stability such that the polymeric foam expands no more than 1% in any direction upon exposure to a temperature of greater than 180° F. for 1 hour.

In a fifth exemplary embodiment, the present disclosure is directed to a rigid polymeric foam. The rigid polymeric foam comprises a foamable polymer, about 2 to about 12% by weight of at least one blowing agent, and at least one service temperature enhancing agent. The at least one service temperature enhancing agent is dispersed throughout the rigid polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof. The rigid polymeric foam maintains dimensional stability such that the polymeric foam expands no more than 1% in any direction upon exposure to a temperature of greater than 180° F. for 1 hour.

### BRIEF DESCRIPTION OF THE DRAWINGS

Various aspects and advantages of the present disclosure will become more readily apparent to those of ordinary skill in the relevant art after reviewing the following detailed description and accompanying drawings, wherein:

FIG. 1 is a schematic illustration of an extrusion apparatus for forming a rigid, closed cell polymeric foam according to at least one exemplary embodiment of the present disclosure;

FIG. 2 is an optical microscope image of glass fiber at 50× magnification as illustrated in the image;

FIG. 3 is an optical microscope image of poly para-phenyleneterephthalamide floc at 50× magnification;

FIG. 4 is an optical microscope image of poly para-phenyleneterephthalamide pulp at 50× magnification;

FIG. 5 is an optical microscope image of poly para-phenyleneterephthalamide pulp at 100× magnification;

FIG. 6 illustrates an exemplary embodiment of a wind blade incorporating an exemplary embodiment of a rigid, closed cell polymeric foam;

FIG. 7 graphically illustrates data obtained from testing of polystyrene foams that contained 20 wt % glass fibers;

FIGS. 8a and 8b are scanning electron microscope images of polystyrene foam that contain 20 wt % glass fibers; and

FIG. 9 graphically illustrates data obtained from testing of polystyrene foams that contained 2.5 wt % poly para-phenyleneterephthalamide pulp.

### DETAILED DESCRIPTION

While embodiments encompassing the general inventive concepts may take various forms, there is shown in the drawings and will hereinafter be described various embodiments with the understanding that the present disclosure is to be considered merely an exemplification and is not intended to be limited to the specific embodiments.

Unless defined otherwise, all technical and scientific terms used herein have the same meaning as commonly understood by one of ordinary skill in the art to which the disclosure belongs. In the drawings, the thickness of the lines, layers, and regions may be exaggerated for clarity. It is to be noted that like numbers found throughout the figures denote like elements. The terms “top,” “bottom,” “front,” “back,” “side,” “upper,” “under,” and the like are used herein for the purpose of explanation only. It will be understood that when an element such as a layer, region, area, or panel is referred to as being “on” another element, it can be directly on the other element or intervening elements may be present. If an element or layer is described as being “adjacent to” or “against” another element or layer, it is to be appreciated that that element or layer may be directly adjacent to or directly against that other element or layer, or intervening elements may be present. It will also be understood that when an element such as a layer or element is referred to as being “over” another element, it can be directly over the other element, or intervening elements may be present.

As it pertains to the present disclosure, “closed cell” refers to a polymeric foam having cells, at least 95% of which are closed. However, in the present application, cells may be “open cells” or closed cells (i.e., certain embodiments disclosed herein may exhibit an “open cell” polymeric form structure).

As it pertains to the present disclosure, “maximum service temperature” refers to the greatest temperature at which a rigid, closed cell polymeric foam retains dimensional stability. As it pertains to the present disclosure, “dimensional stability” is achieved when a particular embodiment of a rigid, closed cell polymeric foam does not dimensionally change more than 1% in any single direction. As the temperature of a rigid, closed cell polymeric foam increases above a certain point (i.e., above its maximum service temperature), the rigid, closed cell polymeric foam tends to change shape (i.e., deform) in at least one direction. The maximum service temperature of a rigid, closed cell polymeric foam is the temperature where a deformation of 1% occurs in any single direction.

Throughout this disclosure, the terms “rigid, closed cell polymeric foam” and “rigid, closed cell polymeric foam insulation board” are used. It should be understood that one can be substituted for the other, and any element recited toward one of the terms should be understood to be disclosed to each the rigid, closed cell polymeric foam and the rigid, closed cell polymeric foam insulation board.

In a first exemplary embodiment, the present disclosure is directed to a rigid, closed cell polymeric foam. The rigid, closed cell polymeric foam comprises about 70 to about 96% by weight foamable polymer, about 2 to about 12% by weight of at least one blowing agent, and 0.01 to 10% by weight polyaramid having a branched fibrous structure. The polyaramid having a branched fibrous structure is dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam expands no more than 1% in any direction upon exposure to a temperature of 180° F. for 1 hour.

In a second exemplary embodiment, the present disclosure is directed to a rigid, closed cell polymeric foam insulation board. The rigid, closed cell polymeric foam insulation board comprises about 70 to about 96% by weight polystyrene, about 2 to about 12% by weight of at least one blowing agent, and 0.01 to 10% by weight polyaramid having a branched fibrous structure. The polyaramid having a branched fibrous structure is dispersed throughout the rigid, closed cell polymeric foam insulation board. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam insulation board expands no more than 1% in any direction upon exposure to a temperature of 180° F. for 1 hour.

In a third exemplary embodiment, the present disclosure is directed to a rigid, closed cell polymeric foam. The rigid, closed cell polymeric foam comprises about 60 to about 75% by weight polystyrene, about 2 to about 12% by weight of at least one blowing agent, and about 15 to about 25% by weight glass fibers. The glass fibers are dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide, and combinations thereof. The rigid, closed cell polymeric foam expands no more than 1% in any direction upon exposure to a temperature of 180° F. for 1 hour.

In a fourth exemplary embodiment, the present disclosure is directed to a rigid, closed cell polymeric foam. The rigid, closed cell polymeric foam comprises polystyrene, about 2 to about 12% by weight of at least one blowing agent, and at least one service temperature enhancing agent. The at least one service temperature enhancing agent is dispersed throughout the rigid, closed cell polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof. The rigid, closed cell polymeric foam maintains dimensional stability such that the polymeric foam expands no more than 1% in any direction upon exposure to a temperature of greater than 180° F. for 1 hour.

In a fifth exemplary embodiment, the present disclosure is directed to a rigid polymeric foam. The rigid polymeric foam comprises a foamable polymer, about 2 to about 12% by weight of at least one blowing agent, and at least one service temperature enhancing agent. The at least one service temperature enhancing agent is dispersed throughout the rigid polymeric foam. The blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof. The rigid polymeric foam maintains dimensional stability such that the polymeric foam expands no more than 1% in any direction upon exposure to a temperature of greater than 180° F. for 1 hour.

The present disclosure relates to extruded polymeric foams that contain one or more fibrous additives as a service temperature enhancing agent to increase the maximum service temperature of the polymeric foam. The service temperature enhancing agent increases the maximum service temperature of the polymeric foam without detrimentally affecting its physical or thermal properties, and without requiring any significant change in the extrusion manufacturing process. The composition used to form the extruded foams having an elevated maximum service temperature includes a foamable polymer, at least one blowing agent, and at least one service temperature enhancing agent.

The foamable polymer is the backbone of the formulation and provides strength, flexibility, toughness, and durability to the final product. The foamable polymer is not particularly limited, and generally, any polymer capable of being foamed may be used as the foamable polymer. The foamable polymer may be thermoplastic or thermoset.

The particular polymer may be selected to provide sufficient mechanical strength to form final foamed polymer products. In addition, the foamable polymer is preferably chemically stable, i.e., generally non-reactive, within the expected temperature range during formation and subsequent use in a polymeric foam. In certain exemplary embodiments, the neat polymer (as opposed to, e.g., the foamed polymer, which contains ingredients in addition to the polymer) has a glass transition temperature ranging from 210 to 260 degrees Fahrenheit.

As used herein, the term “polymer” is generic to the terms “homopolymer,” “copolymer,” “terpolymer,” and combinations of homopolymers, copolymers, and/or terpolymers. Non-limiting examples of suitable foamable polymers include alkenyl aromatic polymers, polyvinyl chloride (“PVC”), chlorinated polyvinyl chloride (“CPVC”), polyethylene, polypropylene, polycarbonates, polyisocyanurates, polyetherimides, polyamides, polyesters, polycarbonates, polymethylmethacrylate, polyphenylene oxide, polyurethanes, phenolics, polyolefins, styrene acrylonitrile (“SAN”), acrylonitrile butadiene styrene, acrylic/styrene/acrylonitrile block terpolymer (“ASA”), polysulfone, polyurethane, polyphenylene sulfide, acetal resins, polyamides, polyaramides, polyimides, polyacrylic acid esters, copolymers of ethylene and propylene, copolymers of styrene and butadiene, copolymers of vinylacetate and ethylene, rubber modified polymers, thermoplastic polymer blends, and combinations thereof.

In one exemplary embodiment, the foamable polymer used to form the polymer melt is an alkenyl aromatic polymer. Suitable alkenyl aromatic polymers include alkenyl aromatic homopolymers and copolymers of alkenyl aromatic monomers and copolymerizable ethylenically unsaturated monomers. In addition, the alkenyl aromatic polymer may include minor proportions of non-alkenyl aromatic monomers. The polymer melt may be formed of one or more alkenyl aromatic homopolymers, one or more alkenyl aromatic copolymers, a blend of one or more of each of alkenyl aromatic homopolymers and copolymers, or blends thereof with a non-alkenyl aromatic polymer. The alkenyl aromatic polymer may include greater than 50 or greater than 70 weight percent alkenyl aromatic monomeric units. In certain exemplary embodiments of the present disclosure, the alkenyl aromatic polymer is formed entirely of alkenyl aromatic monomeric units.

Examples of alkenyl aromatic polymers include, but are not limited to, those alkenyl aromatic polymers derived from alkenyl aromatic monomers such as styrene, α-methylstyrene, ethylstyrene, vinyl benzene, vinyl toluene, chlorostyrene, and bromostyrene. In at least one exemplary embodiment, the alkenyl aromatic polymer is polystyrene.

In certain exemplary embodiments, minor amounts of monoethylenically unsaturated monomers such as C₂ to C₆ alkyl acids and esters, ionomeric derivatives, and C₂ to C₆ dienes may be copolymerized with alkenyl aromatic monomers to form the alkenyl aromatic polymer. Non-limiting examples of copolymerizable monomers include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

In certain exemplary embodiments, the foamable polymer melts may be formed substantially of (e.g., greater than 95 percent), and in certain exemplary embodiments, formed entirely of polystyrene. The foamable polymer may be present in the polymeric foam in an amount from about 60% to about 96% by weight, in an amount from about 60% to about 75% by weight, in an amount from about 70% to about 96% by weight, or in an amount from about 85% to about 96% by weight. In certain exemplary embodiments, the foamable polymer may be present in an amount from about 90% to about 96% by weight. As used herein, the term “% by weight” and “wt %” are used interchangeably and are meant to indicate a percentage based on 100% of the total weight of the dry components.

It is to be appreciated that the properties of the rigid polymeric foam, rigid, closed cell polymeric foam or rigid, closed cell polymeric foam insulation board may be modified by the selection of the molecular weight of the foamable polymer. For example, the preparation of lower density extruded foam products is facilitated by using lower molecular weight polymers. On the other hand, the preparation of higher density extruded foam products is facilitated by the use of higher molecular weight polymers or higher viscosity resins.

As previously discussed, the rigid polymeric foam, rigid, closed cell polymeric foam or rigid, closed cell polymeric foam insulation board includes at least one blowing agent. Generally, any blowing agent(s) suitable for use in preparing rigid, closed cell polymer foam may be used in the practice on this disclosure as the at least one blowing agent. However, due to increased environmental concern over global warming and ozone depletion, in certain exemplary embodiments, the foamable composition is free of blowing agents containing chlorofluorocarbons (“CFCs”). The blowing agents identified herein may be used singly or in combination. As previously discussed, the at least one blowing agent is present in the rigid, closed cell polymeric foam or rigid, closed cell polymeric foam insulation board in an amount from about 2% to about 12% by weight, and in exemplary embodiments, from about 3% to about 10% by weight, or from about 5% to about 8% by weight (based upon the total weight of the rigid, closed cell polymeric foam or rigid, closed cell polymeric foam insulation board).

In certain exemplary embodiments, the at least one blowing agent comprises a hydrofluorocarbon (“HFC”) blowing agent. In exemplary embodiments utilizing at least one hydrofluorocarbon blowing agent, the specific hydrofluorocarbon utilized is not particularly limited. A non-exhaustive, non-limiting list of examples of suitable blowing HFC blowing agents includes 1,1difluoroethane (“HFC-152a”); difluoroethane (“HFC-152”); 1,1,1,2-tetrafluoroethane (“HFC-134a”); 1,1,2,2- tetrafluroethane (“HFC-134”); 1,1,1-trifluoroethane (“HFC-143a”); difluoromethane (“HFC-32”); 1,3,3,3-tetrafluoropropene (“HFO-1234ze”); pentafluoro-ethane (“HFC-125”); fluoroethane (“HFC-161”); 1,1,2,2,3,3-hexafluoropropane (“HFC 236ca”); 1,1,1,2,3,3-hexafluoropropane (“HFC-236ea”); 1,1,1,3,3,3-hexafluoropropane (“HFC-236fa”); 1,1,1,2,2,3-hexafluoropropane (“HFC-245ca”); 1,1,2,3,3-pentafluoropropane (“HFC-245ea”); 1,1,1,2,3-pentafluoropropane (“HFC-245eb”); 1,1,1,3,3-pentafluoropropane (“HFC-245fa”); 1,1,1,4,4,4-hexafluorobutane (“HFC-356mff”); 1,1,1,3,3-pentafluorobutane (“HFC-365mfc”); FEA-1100 (available from E.I. du Pont de Nemours and Company, hereinafter “DuPont”); 2,3,3,3-tetrafluoroprop-1-ene (“R-1234YF” from Arkema); and combinations thereof. In at least one exemplary embodiment, the blowing agent is HFC-152a, HFC-134a, or a combination thereof.

In some embodiments, the blowing agent may comprise one or more hydrofluoroolefin blowing agents, including, but not limited to, 3,3,3-trifluoropropene (HFO-1243zf); 2,3,3-trifluoropropene; (cis and/or trans)-1,3,3,3-tetrafluoropropene (HFO-1234ze), particularly the trans isomer; 1,1,3,3-tetrafluoropropene; 2,3,3,3-tetrafluoropropene (HFO-1234yf); (cis and/or trans)-1,2,3,3,3-pentafluoropropene (HFO-1225ye); 1,1,3,3,3-pentafluoropropene (HFO-1225zc); 1,1,2,3,3-pentafluoropropene (HFO-1225yc); hexafluoropropene (HFO-1216); 2-fluoropropene, 1-fluoropropene; 1,1-difluoropropene; 3,3-difluoropropene; 4,4,4-trifluoro-1-butene; 2,4,4,4-tetrafluorobutene-1; 3,4,4,4-tetrafluoro-1-butene; octafluoro-2-pentene (HFO-1438); 1,1,3,3,3-pentafluoro-2-methyl-1-propene; octafluoro-1-butene; 2,3,3,4,4,4-hexafluoro-1-butene; 1,1,1,4,4,4-hexafluoro-2-butene (HFO-1336m/z); 1,2-difluoroethene (HFO-1132); 1,1,1,2,4,4,4-heptafluoro-2-butene; 3-fluoropropene, 2,3-difluoropropene; 1,1,3-trifluoropropene; 1,3,3-trifluoropropene; 1,1,2-trifluoropropene; 1-fluorobutene; 2-fluorobutene; 2-fluoro-2-butene; 1,1-difluoro-I-butene; 3,3-difluoro-I-butene; 3,4,4-trifluoro-I-butene; 2,3,3-trifluoro-1-butene; I,1,3,3-tetrafluoro-I-butene; 1,4,4,4-tetrafluoro-1-butene; 3,3,4,4-tetrafluoro-1-butene; 4,4-difluoro-1-butene; I,I,1-trifluoro-2-butene; 2,4,4,4-tetrafluoro-1-butene; 1,1,1,2-tetrafluoro-2 butene; 1,1,4,4,4-pentafluorol-butene; 2,3,3,4,4-pentafluoro-1- butene; 1,2,3,3,4,4,4-heptafluoro-1-butene; 1,1,2,3,4,4,4-heptafluoro-1-butene; and 1,3,3,3-tetrafluoro-2-(trifluoromethyl)-propene. Other blowing agents useful in the practice of this disclosure include inorganic blowing agents, organic blowing agents, and chemical blowing agents. Non-limiting examples of inorganic, organic, or chemical blowing agents suitable for use in the present disclosure include C₂ to C₉ aliphatic hydrocarbons (e.g., ethane, propane, n-butane, cyclopentane, isobutane, n-pentane, isopentane, and neopentane); C₁ to C₅ aliphatic and non-aliphatic alcohols (e.g., methanol, ethanol, n-propanol, isopropanol, and butanol); natural gases such as air, carbon dioxide (CO₂), nitrogen (N₂), and/or argon (Ar); water; ketones (e.g., acetone and methyl ethyl ketone); ethers (e.g., dimethyl ethers and diethyl ethers); methyl formate; acetone; and hydrogen peroxide may also be used as blowing agents.

The rigid polymeric foam, rigid, closed cell polymeric foam or rigid, closed cell polymeric foam insulation board includes at least one service temperature enhancing agent. The service temperature enhancing agent is not particularly limited, and may be any service temperature enhancing agent that is suitable for use in polymeric foams. The service temperature enhancing agent may include any straight or branched fibrous additive. Examples of service temperature enhancing agents include, but are not limited to, glass fibers or polyaramid fibers. In certain exemplary embodiments, the service temperature enhancing agent is a polyaramid having a branched fibrous structure. In some exemplary embodiments, the service temperature enhancing agent is poly para-phenyleneterephthalamide aramid fibers, available under the trade name KEVLAR by DuPont. Poly para-phenyleneterephthalamide aramid fibers are available in floc and pulp, with the pulp having a branched fibrous structure. To make poly para-phenyleneterephthalamide pulp, poly para-phenyleneterephthalamide floc is subjected to intensive mechanical grinding, producing poly para-phenyleneterephthalamide pulp, which has a branched fibrous structure. In certain exemplary embodiments, poly para-phenyleneterephthalamide pulp has a density ranging from 1.4 to 1.5 g/cm³ and a specific surface area ranging from 7 to 11 m²/g. In certain exemplary embodiments, the poly para-phenyleneterephthalamide pulp is a poly para-phenyleneterephthalamide nano-pulp.

Because of the relative difficulty in incorporating the polyaramid having a branched fibrous structure into the polymer melt within an extruder, in certain exemplary embodiments, the polyaramid having a branched fibrous structure is first compounded with a polymer to form a master batch (i.e., a master batch of polyaramid having a branched fibrous structure and foamable polymer is formed). In the absence of compounding, the polyaramid having a branched fibrous structure is difficult to disperse throughout a polymeric foam via extrusion. In certain exemplary embodiments, the polyaramid having a branched fibrous structure is compounded with a resin to form a resin-branched polyaramid compound. In certain exemplary embodiments, the resin-branched polyaramid compound includes resin at a weight percent ranging from 70 to 99, and polyaramid having a branched fibrous structure at a weight percent ranging from 1 to 30. In certain exemplary embodiments, the resin-branched polyaramid compound includes resin at a weight percent ranging from 85 to 95, and polyaramid having a branched fibrous structure at a weight percent ranging from 5 to 15. In certain exemplary embodiments, the resin is polystyrene. In certain exemplary embodiments, the branched polyaramid is poly para-phenyleneterephthalamide pulp or nano-pulp.

In at least the first and second exemplary embodiments, the rigid, closed cell polymeric foam or rigid, closed cell polymeric foam insulation board contains from 0.01 to 10 weight percent polyaramid. In certain exemplary embodiments, the rigid polymeric foam, rigid, closed cell polymeric foam or rigid, closed cell polymeric foam insulation board contains from 0.1 to 8 weight percent polyaramid having a branched fibrous structure. In certain exemplary embodiments, the rigid polymeric foam, rigid, closed cell polymeric foam or rigid, closed cell polymeric foam insulation board contains from 1 to 5 weight percent polyaramid having a branched fibrous structure. In certain exemplary embodiments, the rigid polymeric foam, rigid, closed cell polymeric foam or rigid, closed cell polymeric foam insulation board contains from 2 to 4 weight percent polyaramid having a branched fibrous structure.

Once formed via extrusion, in certain exemplary embodiments, the rigid polymeric foam, rigid, closed cell polymeric foam or rigid, closed cell polymeric foam insulation board that contains 0.01-10 weight percent polyaramid having a branched fibrous structure has an elevated maximum service temperature. In certain exemplary embodiments of the present disclosure, the rigid polymeric foam, rigid, closed cell polymeric foam or rigid, closed cell polymeric foam insulation board achieves an increase in maximum service temperature ranging from 10 to 40° F. as compared to a rigid polymeric foam, rigid, closed cell polymeric foam or rigid, closed cell polymeric foam insulation board that is identical except for not including a service temperature enhancing agent such as a polyaramid having a branched fibrous structure. In certain exemplary embodiments, the rigid polymeric foam, rigid, closed cell polymeric foam or rigid, closed cell polymeric foam insulation board has a maximum service temperature of greater than about 180° F. In certain exemplary embodiments, the rigid polymeric foam, rigid, closed cell polymeric foam or rigid, closed cell polymeric foam insulation board has a maximum service temperature of greater than about 190° F. In certain exemplary embodiments, the rigid polymeric foam, rigid, closed cell polymeric foam or rigid, closed cell polymeric foam insulation board has a maximum service temperature of greater than about 200° F. In certain exemplary embodiments, the rigid polymeric foam, rigid, closed cell polymeric foam or rigid, closed cell polymeric foam insulation board has a maximum service temperature ranging from 190 to 240° F. In certain exemplary embodiments, the rigid polymeric foam, rigid, closed cell polymeric foam or rigid, closed cell polymeric foam insulation board has a maximum service temperature ranging from 195 to 225° F.

In certain exemplary embodiments, the rigid, closed cell polymeric foam or rigid, closed cell polymeric foam insulation board has an average cell size ranging from 0.01 to 1 millimeter. In certain exemplary embodiments, the rigid, closed cell polymeric foam or rigid, closed cell polymeric foam insulation board has an average cell size ranging from 0.05 to 0.4 millimeter.

In certain exemplary embodiments, the rigid polymeric foam, rigid, closed cell polymeric foam or rigid, closed cell polymeric foam insulation board further comprises a fibrous material in addition to the service temperature enhancing agent. In certain exemplary embodiments, the fibrous material in addition to the service temperature enhancing agent (the “additional fibrous material”) is selected from the group consisting of: chopped glass fibers, carbon fibers, nano-carbon fibers, nano-carbon tubes, nylon fibers, poly(ethylene terephthalate) fibers, branched or unbranched polyaramid fibers, and combinations thereof.

In certain exemplary embodiments the additional fibrous material is present in the rigid polymeric foam, rigid, closed cell polymeric foam or rigid, closed cell polymeric foam insulation board in an amount ranging from 1 to 20 percent by weight. In certain exemplary embodiments the additional fibrous material is present in the rigid polymeric foam, rigid, closed cell polymeric foam or rigid, closed cell polymeric foam board in an amount ranging from 3 to 12 percent by weight. In certain exemplary embodiments the additional fibrous material is present in the rigid polymeric foam, rigid, closed cell polymeric foam or rigid, closed cell polymeric foam board in an amount ranging from 4 to 10 percent by weight.

In certain exemplary embodiments, a coupling agent is present along with the additional fibrous material, wherein the coupling agent may be an amino silane compound. In certain embodiments, the amino silane compound is G-amino propyl-triethoxy silane, available from Momentive Perforamnce LLC, Old Saw Mill River Road, Tarrytown, N.Y. 10591.

Further, the rigid polymeric foam, rigid, closed cell polymeric foam or the rigid, closed cell polymeric foam insulation board may contain a flame retarding agent in an amount up to about 2% by weight. For example, one or more flame retarding agents may be added in the extruded foam manufacturing process to impart flame retardant characteristics to the rigid polymeric foam, rigid, closed cell polymeric foam or the rigid, closed cell polymeric foam insulation board. In certain exemplary embodiments, the flame retarding agent is added to the polymer melt. Non-limiting examples of suitable flame retarding agents for use in the rigid polymeric foam, rigid, closed cell polymeric foam or the rigid, closed cell polymeric foam insulation board include brominated aliphatic compounds such as hexabromocyclododecane (“HBCD”) and pentabromocyclohexane; brominated phenyl ethers; esters of tetrabromophthalic acid; and combinations thereof.

Optional additives such as nucleating agents, plasticizing agents, pigments, elastomers, extrusion aids, antioxidants, fillers, antistatic agents, biocides, and/or UV absorbers may be incorporated into the rigid polymeric foam, rigid, closed cell polymeric foam or the rigid, closed cell polymeric foam insulation board. These optional additives may be included in amounts necessary to obtain desired characteristics of the polymer melt, or the rigid, closed cell polymeric foam (insulation board) that results from the extrusion process. When utilized, the optional additives may be added to the polymer melt, or the optional additives may be incorporated into the foamable polymer before, during, or after the polymerization process used to make the foamable polymer.

Turning to the figures, FIG. 1 is a schematic illustration of a screw extrusion apparatus 10 suitable for preparing a rigid, closed cell polymeric foam or rigid, closed cell polymeric foam insulation board according to at least one exemplary embodiment of the present disclosure. Screw extruders suitable for use in preparing the rigid, closed cell polymeric foam or rigid, closed cell polymeric foam insulation board disclosed herein may equally be a single screw or twin screw extruder. FIG. 1 illustrates a single screw extruder. The screw extruder 10 is formed of a barrel 12 and at least one screw 14 that extends substantially along the length of the barrel 12. A motor (M) may be used to power the screw 14. The screw 14 contains helical flights 16 rotating in the direction of arrow 18. The flights 16 of the screw 14 cooperate with the cylindrical inner surface of the barrel 12 to define a passage for the advancement of the resin and reinforcement fibers through the barrel 12. The foamable polymer and may be fed into the screw extruder 10 as flowable solid, such as beads, granules, or pellets from one or more feed hoppers 20 and 22.

As the foamable polymer flows through the extruder 10 in the direction of arrow 18, the spacing between the flights 16 of the screw 14 decreases. Thus, the volume between the flights 16 decreases as the polymer melt flows downstream. The term “downstream” as used herein refers to the direction of resin and fiber flow through the barrel 12. This decreasing volume, together with the mechanical action and friction generated from the barrel 12 and the screw 14, causes the foamable polymer to melt and form the polymer melt.

It is to be appreciated that the flights 16 of the screw 14 cooperate with the cylindrical inner surface of the barrel 12 to define a passage for the advancement of the polymer melt through the barrel 12. As shown in FIG. 1, while some additives may be added along with the foamable polymer that becomes the polymer melt, optional hoppers (e.g., hopper 22) and ports (e.g., port 24) may be provided at any of various positions on the extruder for the insertion of one or more additives as necessary or desired. The additives may include, but are not limited to, service temperature enhancing agents. Non-limiting examples of additives include, for example, branched polyaramid fibers, unbranched polyaramid fibers, any variety of glass fibers, carbon fibers, nano-carbon fibers, nano-carbon tubes, nylon fibers, poly(ethylene terephthalate) fibers, and combinations thereof; infrared attenuating agents; one or more blowing agent(s); flame retardants; cell size enlarging agents; nucleating agents; biocides; plasticizing agents; elastomers; extrusion aids; antioxidants; antistatic agents; mold release agents; pigments; fillers; and combinations thereof.

In at least one embodiment, the foamable polymer and the master batch are substantially simultaneously fed into the barrel 12 of the extruder 10 through either or both feed hoppers 20 and 22. As used herein, the term “substantially simultaneously fed” is meant to indicate that the foamable polymer and the master batch are fed into the barrel 12 at the same time or at nearly the same time.

Once the foamable polymer, blowing agent(s), and the master batch have been introduced into the barrel 12, the resulting foamable mixture is subjected to additional blending to substantially uniformly distribute the blowing agent(s) and the service temperature enhancing agent throughout the polymer melt.

The heat from the internal friction from the screw 14 within the barrel 12 causes the blowing agent to be uniformly or substantially uniformly dispersed within the polymer melt for improved solubility. The polymer melt is subsequently cooled to a lower temperature in a melt cooler 25 and then conveyed from the extruder 10 through an extrusion die 26 which is designed to shape the foam into a desired shape and to create a pressure drop which permits the blowing agent to expand and develop a foamed cell structure in the form of a foam layer or slab. In particular, the foamable mixture enters an area of reduced pressure as it exits the die 26. The rigid, closed cell polymeric foam may be subjected to additional processing such as calendaring, water immersion, cooling sprays, post-steaming, or other operations to control the thickness and other properties of the resulting rigid, closed cell polymeric foam, which in an exemplary embodiment is a rigid, closed cell polymeric foam insulation board.

FIGS. 2-5 show microscopic photographs of glass fibers (FIG. 2, 50× magnification), poly para-phenyleneterephthalamide floc (FIG. 3, 50× magnification), and poly para-phenyleneterephthalamide pulp (FIGS. 4 and 5, 50× and 100× magnification, respectively). When comparing FIGS. 3, 4, and 5, the branched fibrous structure of the poly para-phenyleneterephthalamide pulp is clearly evident in FIGS. 4 and 5.

In certain embodiments, the rigid polymeric foam, rigid, closed cell polymeric foam or rigid, closed cell polymeric foam insulation board of the present disclosure is utilized or suitable for use in applications for which rigid polymeric foams, rigid, closed cell polymeric foams or rigid, closed cell polymeric foam insulation boards were not previously suitable because of their previously limited maximum service temperature. For example, during warm sunny days, temperatures at or near a roofing surface may exceed 160° F., previously preventing the use of polystyrene insulation board. In certain exemplary embodiments, a rigid, closed cell polymeric foam insulation board comprising polystyrene and a fibrous additive (e.g., polyaramid having a branched fibrous structure and/or glass fibers) is utilized as roofing insulation. As it pertains to the present disclosure, “utilized as roofing insulation” refers to the application of insulation board directly under or substantially directly under a roofing deck. The roofing deck may be a metal panel, a wooden board, or the like, which may be covered with an asphalt coating or shingles. While one or more materials may be disposed between the roofing deck and the insulation board, one of skill in the art will readily recognize whether the insulation board is being “utilized as roofing insulation” as opposed to, for example, attic insulation, because being “utilized as roofing insulation” requires the insulation board to be adjacent to the roofing deck as previously described and defined.

FIG. 6 illustrates an exemplary embodiment of a wind blade 500 used for driving a wind turbine. Wind blades are generally constructed as comprising a root 510, a spar 540, a shell 550, one or more surface coatings 560 and 570, a structural adhesive 580, and one or more shear webs 520 and 530. The shear webs 520 and 530 have been typically formed of a wooden material such as balsa wood, or, for example, a polymeric foam formulated with a blend of flexible vinyl-containing polymer (e.g., polyvinyl chloride) with polyurea and/or polyisocyanurate chemistries. These materials have provided good thermal stability during the epoxy infusion application utilized in typical wind blade manufacture.

In certain exemplary embodiments, the present disclosure is directed to a wind blade comprising: a root; a spar; a shell; a surface; and a shear web comprising the rigid, closed cell polymeric foam as described herein. In certain exemplary embodiments, the rigid, closed cell polymeric foam comprises from about 70 to about 96% by weight polystyrene, from about 4 to about 12% by weight blowing agent, and from 0.01 to 10% by weight polyaramid having a branched fibrous structure.

### EXAMPLES

The following Examples are presented to further illustrate various embodiments of the present disclosure and should not be construed as limiting.

The glass transition temperature of polystyrene is known to be around 105° C. (221° F.). When polystyrene is used to prepare rigid, closed cell polymeric foam or rigid, closed cell polymeric foam insulation board, once the application temperature (i.e., the use temperature for the particular application in with the rigid, closed cell polystyrene foam board is being used) approaches the glass transition temperature, the polystyrene matrix begins to expand, losing its dimensional stability. While not wishing to be bound to any particular theory, it is believed that, when the temperature of a rigid, closed cell polymeric foam rises above a certain point, the gas phase located within the foam cells (mainly one or more blowing agents) expands. This expansion is believed to affect the dimensional stability of the rigid, closed cell polymeric foam.

Traditionally, foamable polymers having relatively high glass transition temperatures have been utilized to modify the heat distortion properties of one or more foamable polymers having relatively low glass transition temperatures (e.g., polystyrene). However, a comparatively large amount of one or more of the foamable polymers having relatively high glass transition temperatures usually needs to be incorporated into the polymer melt in order to significantly impact the behavior or significantly increase the maximum service temperature of the foamable polymer having the relatively low glass transition temperature. The comparatively large amount of the high glass transition temperature foamable polymer will significantly change the rheological properties of the resulting polymeric foam, thereby resulting in a difficult foaming process. Increasing the content of open cells in the polymeric foam has also been attempted in order to release the expansion force from the gas phase diffusion, to the detriment of other mechanical properties of the resulting polymeric foam.

As it pertains to the present disclosure and more particularly the Examples, maximum service temperature is determined using the following procedure. A cubic rigid, closed cell polymeric foam sample is placed in an oven and the temperature of the oven is raised in 10° F. increments beginning at a relatively low set point (e.g., 140° F.). At each temperature rising step, the foam sample will be kept in the oven for one hour and then changes in its three dimensions will be measured using, for example, a measuring tape or digital caliper and compared to the original values, by which the percentage of each dimensional change is calculated. The maximum acceptable dimensional change in any single dimension is 1%, with the temperature corresponding with the 1% change in any single dimension defined as the maximum service temperature.

As explained in greater detail below, two kinds of fibrous additives were used to prepare rigid, closed cell polymeric foams from polystyrene: chopped glass fibers from Owens Corning and poly para-phenyleneterephthalamide pulp from DuPont. Table 1 summarizes various characteristics of the two fiber materials.

TABLE 1
Characteristics of the glass fibers and the poly
para-phenyleneterephthalamide pulp

| | | Product | | |
|---|---|---|---|---|
| Fibers | Vendor | number | Properties | Shape |
| Glass fibers | Owens | 995-10P | Diameter: 10 μm | straight |
| | Corning | | Length: 4 mm | |
| Poly para- | DuPont | 1F538 | Specific gravity: 1.45 | branched |
| phenyleneterephthalamide | | | Specific surface area: 7-11 m²/g | |
| pulp | | | Bulk density: 3-10 lb/ft³ | |

The glass fibers were composed of continuous ADVANTEX® glass strands that had been manufactured with specific chemical sizing to maximize polymer, in this case polystyrene, compatibility. These continuous strands were then chopped into specified lengths. The chopped strands are offered in a pelletized form to promote optimum glass handling and feeding characteristics.

### Example 1

### Incorporation of 20% Chopped Glass Fibers in Extruded Polystyrene Foam

Fed directly into a single screw extruder were polystyrene (balance), 7.8 wt % 50/50 blend of HFC-134a/HFC-152a (blowing agents), 1 wt % hexabromocyclododecane (“HBCD”) (a flame retarding agent), 0.2% graphite (a nucleating agent), and 20 wt % of fiber glass chopped strand. The ingredients were foamed at the exit of the foaming die. The extruder was operated at a production rate of approximately 100 to 160 kg/hr and the blowing agent used was a 50/50 blend of HFC-134a/HFC-152a. Foam boards having varying thicknesses and greater than 20 inches wide were made with a foaming die temperature between 110 to 130° C. and a foaming die pressure between 800 to 1100 psig.

Table 2 lists the properties for rigid, closed cell polymeric foams made in this trial, including eight control samples that did not incorporate glass fibers and eight trial samples incorporating 20% by weight glass fibers. The purpose of the eight variations for the control and trial samples was to investigate the foam properties at different operating conditions, for example, die temperature and board thickness. The die temperature may influence the foam cell growth rate, and the board thickness may impact the cell orientation to some extent. The foam densites for foam boards incorporating chopped glass fibers are higher overall than the controls because glass fiber itself has a much higher density than polystyrene.

TABLE 2
Properties of samples with and without 20 wt % fiber glass.

| Sam- | Fiber | | Cell | Board | Compressive | Compressive |
|---|---|---|---|---|---|---|
| ple | Glass | Density | Size | thickness | Strength | Modulus |
| # | (wt %) | (pcf) | (mm) | (in) | (psig) | (psig) |
| w1 | 0 | 2.70 | 0.14 | 0.96 | 55.6 | 1748.1 |
| w2 | 0 | 2.11 | 0.16 | 1.08 | 39.8 | 1435.3 |
| w3 | 20 | 3.48 | 0.15 | 0.85 | 66.5 | 1674.4 |
| w4 | 20 | 2.78 | 0.15 | 0.94 | 50.5 | 1391.8 |
| w5 | 20 | 4.15 | 0.14 | 1.00 | 95.1 | 2782.1 |
| w6 | 20 | 3.39 | 0.15 | 1.09 | 71.2 | 2126.6 |
| w7 | 0 | 2.39 | 0.15 | 1.01 | 56.5 | 1774.9 |
| w8 | 0 | 2.24 | 0.16 | 1.15 | 44.9 | 1476.2 |
| w9 | 0 | 2.74 | 0.15 | 1.43 | 75.8 | 3924 |
| w10 | 0 | 2.10 | 0.15 | 1.54 | 52 | 2497.6 |
| w11 | 20 | 3.36 | 0.14 | 1.06 | 61.1 | 1298.6 |
| w12 | 20 | 3.22 | 0.15 | 1.09 | 58.6 | 1188.3 |
| w13 | 20 | 3.85 | 0.15 | 1.01 | 74.6 | 1685.7 |
| w14 | 20 | 3.26 | 0.15 | 1.09 | 60.8 | 1223.8 |
| w15 | 0 | 2.91 | 0.15 | 1.48 | 85.8 | 3793.5 |
| w16 | 0 | 2.22 | 0.16 | 1.58 | 59.4 | 2675.8 |

The dimensional change of the samples listed in Table 2 with increasing temperature is illustrated in FIG. 7. All eight samples incorporating 20 wt % glass fibers (w3-w6 and w11-w14) exhibit a later dimensional expansion behavior (i.e., are able to withstand a relatively higher temperature before experiencing the same amount of expansion as the control samples). Treating 1% dimensional change as the maximum acceptable criterion, trial samples incorporating 20 wt % glass fibers have a maximum service temperature between 190 to 200° F., versus 160 to 180° F. for the eight control samples. Thus, an improvement in maximum service temperature of from 10-40° F. was realized by incorporating 20 wt % glass fibers into the polymer melt to form the rigid, closed cell polymeric foam. The maximum service temperatures of samples w1-w16 are listed in Table 3.

FIGS. 8a and 8b show SEM photographs at differing magnifications of a rigid, closed cell polymeric foam sample that incorporates glass fibers. The dispersion of glass fibers in FIGS. 8a and 8b is not the same as what has been commonly understood in the field of polymer/fiber composites, in which fibers spread throughout the polymer matrix. In FIGS. 8a and 8b, the glass fibers mostly penetrate the rigid, closed cell polymeric foam cell walls and stand out of the polystyrene matrix. While not wishing to be bound to any particular theory, the location of the glass fibers may be due to the glass fibers' relatively large size when compared to the cell wall thickness and strut size of the polystyrene matrix. Therefore, it would be expected that the effectiveness will be highly dependent upon the adhesive strength between the surface of the glass fibers and the rigid, closed cell polymeric foam cell walls. The glass fibers appear to form a structure similar to that of a scaffold, thereby confining the movement of rigid, closed cell polymeric foam structures when heated. Enhancing the surface compatibility between glass fibers and the foamed polymer matrix should lead to a decreased amount of glass fibers needed in the foamable polymer in order to gain the same improvement in maximum service temperature.

TABLE 3
Maximum service temperature with 1 wt %
maximum dimensional change.

| | Maximum Service |
|---|---|
| Sample # | Temperature (° F.) |
| w1 | 174 |
| w2 | 180 |
| w3 | 198 |
| w4 | 196 |
| w5 | 200 |
| w6 | 198 |
| w7 | 175 |
| w8 | 170 |
| w9 | 162 |
| w10 | 160 |
| w11 | 198 |
| w12 | 194 |
| w13 | 195 |
| w14 | 191 |
| w15 | 182 |
| w16 | 178 |

### Example 2

### Incorporation of 2.5 wt % Poly Para-Phenyleneterephthalamide Pulp in Extruded Polystyrene Foam

For Example 2, the heat expansion of extruded polystyrene foam was shown to be limited by the presence of poly para-phenyleneterephthalamide pulp dispersed throughout the extruded polystyrene foam. The maximum service temperature of the extruded, rigid, closed cell polystyrene foam that incorporated poly para-phenyleneterephthalamide pulp was highly improved with a relatively low loading level of the poly para-phenyleneterephthalamide pulp as compared to an extruded, rigid, closed cell polystyrene foam made without poly para-phenyleneterephthalamide pulp.

Ten weight percent of poly para-phenyleneterephthalamide pulp was initially compounded with 90 wt % polystyrene to make a compounded additive (i.e., master batch). The compounded additive was used to make extruded polystyrene foam having 2.5 wt % poly para-phenyleneterephthalamide pulp incorporated into the resulting rigid, closed cell polymeric foam.

The blowing agent used was HFC-134a at 5 wt %. The extrusion rate using a lab-scale extruder was about 65 grams/min. The foaming die temperature was 120° C. and the die pressure was 950 psig. Other ingredients such as a flame retarding agent or a nucleating agent were not used in Example 2 because of the small size of the lab scale extruder. No processing difficulties were noticed during extrusion of the polystyrene having the 2.5 wt % poly para-phenyleneterephthalamide pulp as compared to extruded polystyrene foams that do not incorporate poly para-phenyleneterephthalamide pulp (i.e., the control samples and the trial samples each extruded with similarity to one another).

FIG. 9 shows the percentage changes in dimension and volume with increasing temperature for samples incorporating (“N9”) and without (“N0”) 2.5 wt % polyaramid having a branched fibrous structure, which for this example was poly para-phenyleneterephthalamide pulp. The control sample (“N0”) began to expand at less than 160° F. However, the sample incorporating 2.5 wt % poly para-phenyleneterephthalamide pulp (“N9”) showed nearly no change in either dimensions or volume until approximately 200° F. Thus, the addition of polyaramid having a branched fibrous structure in an amount of 2.5% produced an enhancement of approximately 40° F. in maximum service temperature, representing approximately a 25% improvement. Table 4 summarizes various properties of the two samples. The sample incorporating poly para-phenyleneterephthalamide pulp shows increases in tensile strain although it is less dense than the control sample.

TABLE 4
Properties of samples incorporating (“N9”) and without
(“N0”) 2.5 wt % poly para-phenyleneterephthalamide pulp.

| | | N9 (2.5% poly para- |
|---|---|---|
| | N0 | phenyleneterephthalamide |
| Properties | (control) | pulp) |
| Density (pcf) | 6.3 | 5.3 |
| Shear modulus (psi) | 1565.3 | 1121.2 |
| Shear yielding stress (psi) | 49.5 | 34.8 |
| tensile (% strain at MAX load) | 11.7 | 41.4 |
| tensile (% strain at break) | 19.4 | 47.5 |
| tensile (stress at MAX load: psi) | 37.6 | 28.5 |
| tensile modulus (psi) | 1019.9 | 472.0 |
| Compressive stress at 5% (psi) | 62.0 | 22.6 |
| Compressive stress at 10% (psi) | 99.8 | 42.8 |
| Compressive modulus(psi) | 1289.9 | 436.0 |
| Maximum service temperature | <160 | 200 |
| (° F.) | | |

Any patents referred to herein, are hereby incorporated herein by reference, whether or not specifically done so within the text of this disclosure.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. See Bryan A. Garner, A Dictionary of Modern Legal Usage 624 (2d ed. 1995). Also, to the extent that the terms “in” or “into” are used in the specification or the claims, it is intended to additionally mean “on” or “onto.” Furthermore, to the extent that the term “connect” is used in the specification or the claims, it is intended to mean not only “directly connected to,” but also “indirectly connected to” such as connected through another component or components. In the present disclosure, the words “a” or “an” are to be taken to include both the singular and the plural. Conversely, any reference to plural items shall, where appropriate, include the singular.

All ranges and parameters disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The general inventive concepts have been illustrated, at least in part, by describing various exemplary embodiments thereof. While these exemplary embodiments have been described in considerable detail, it is not the Applicant's intent to restrict or in any way limit the scope of the appended claims to such detail. Furthermore, the various inventive concepts may be utilized in combination with one another (e.g., one or more of the first, second, third, fourth, etc. exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A rigid, closed cell polymeric foam comprising:
about 70 to about 96% by weight foamable polymer;
about 2 to about 12% by weight of at least one blowing agent; and
0.01 to 10% by weight polyaramid having a branched fibrous structure;
wherein the polyaramid having a branched fibrous structure is dispersed throughout the rigid, closed cell polymeric foam;
wherein the blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof; and
wherein said rigid, closed cell polymeric foam maintains dimensional stability such that the polymeric foam expands no more than 1% in any direction upon exposure to a temperature of at least about 180° F. for 1 hour.

2. The rigid, closed cell polymeric foam of claim 1, wherein the polyaramid having a branched fibrous structure is a poly para-phenyleneterephthalamide pulp.

3. The rigid, closed cell polymeric foam of claim 1, wherein the rigid, closed cell polymeric foam further comprises about 1 to about 20% by weight of a fibrous material selected from the group consisting of: chopped glass fibers, carbon fibers, nano-carbon fibers, nano-carbon tubes, nylon fibers, poly(ethylene terephthalate) fibers, unbranched polyaramid fibers, and combinations thereof.

4. The rigid, closed cell polymeric foam of claim 3, wherein the fibrous material is chopped glass fibers.

5. The rigid, closed cell polymeric foam of claim 1, wherein the foamable polymer has a glass transition temperature ranging from 210 to 260 degrees Fahrenheit.

6. The rigid, closed cell polymeric foam of claim 1, wherein the foamable polymer is polystyrene.

7. A wind blade comprising: a root; a spar; a shell; a surface; and a shear web comprising the rigid, closed cell polymeric foam of claim 1.

8. The rigid, closed cell polymeric foam of claim 1, wherein the rigid, closed cell polymeric foam has closed cells having an average cell size ranging from 0.01 to 1 mm.

9. A rigid, closed cell polymeric foam insulation board comprising:
about 70 to about 96% by weight polystyrene;
about 2 to about 12% by weight of at least one blowing agent; and
about 0.01 to about 10% by weight polyaramid having a branched fibrous structure;
wherein the polyaramid is dispersed throughout the rigid, closed cell polymeric foam insulation board;
wherein the blowing agent is selected from hydrofluorocarbons, hydrofluoroolefins, C₁ to C₉ aliphatic hydrocarbons, C₁ to C₄ aliphatic alcohols, carbon dioxide, acetone, natural gases, air, water, ketones, ethers, methyl formate, hydrogen peroxide and combinations thereof; and
wherein said rigid, closed cell polymeric foam insulation board maintains dimensional stability such that the polymeric foam expands no more than 1% in any direction upon exposure to a temperature of at least about 180° F. for 1 hour.

10. The rigid, closed cell polymeric foam insulation board of claim 9, wherein the polyaramid having a branched fibrous structure is a poly para-phenyleneterephthalamide pulp.

11. The rigid, closed cell polymeric foam insulation board of claim 9, wherein the rigid, closed cell polymeric foam insulation board further comprises about 1 to about 20% by weight of a fibrous material selected from the group consisting of: chopped glass fibers, carbon fibers, nano-carbon fibers, nano-carbon tubes, nylon fibers, poly(ethylene terephthalate) fibers, unbranched polyaramid fibers, and combinations thereof.

12. The rigid, closed cell polymeric foam insulation board of claim 11, wherein the fibrous material is chopped glass fibers.

13. The rigid, closed cell polymeric foam insulation board of claim 9, wherein the rigid, closed cell polymeric foam insulation board is utilized as roofing insulation.

14. A rigid, closed cell polymeric foam comprising:
about 60 to about 75% by weight polystyrene;
about 2 to about 12% by weight of at least one blowing agent; and
about 15 to about 25% by weight glass fibers;
wherein the glass fibers are dispersed throughout the rigid, closed cell polymeric foam;
wherein the blowing agent is selected from hydrofluorocarbons, hydrofluoroolefins, C₁ to C₉ aliphatic hydrocarbons, C₁ to C₄ aliphatic alcohols, carbon dioxide, acetone, natural gases, air, water, ketones, ethers, methyl formate, hydrogen peroxide and combinations thereof; and
wherein said rigid, closed cell polymeric foam insulation board maintains dimensional stability such that the polymeric foam expands no more than 1% in any direction upon exposure to a temperature of at least about 180° F. for 1 hour.

15. A rigid, closed cell polymeric foam comprising:
polystyrene;
about 2 to about 12% by weight of at least one blowing agent; and
at least one service temperature enhancing agent;
wherein the at least one service temperature enhancing agent is dispersed throughout the rigid, closed cell polymeric foam;
wherein the blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof; and
wherein said rigid, closed cell polymeric foam maintains dimensional stability such that the polymeric foam expands no more than 1% in any direction upon exposure to a temperature of greater than 180° F. for 1 hour.

16. A rigid polymeric foam comprising:
a foamable polymer;
about 2 to about 12% by weight of at least one blowing agent; and
at least one service temperature enhancing agent;
wherein the at least one service temperature enhancing agent is dispersed throughout the rigid polymeric foam;
wherein the blowing agent is selected from hydrofluorocarbons, hydrofluoroolefins, C₁ to C₉ aliphatic hydrocarbons, C₁ to C₄ aliphatic alcohols, carbon dioxide, acetone, natural gases, water, ketones, ethers, methyl formate, hydrogen peroxide and combinations thereof; and
wherein said rigid polymeric foam maintains dimensional stability such that the polymeric foam expands no more than 1% in any direction upon exposure to a temperature of greater than 180° F. for 1 hour.

17. The rigid polymeric foam of claim 16, wherein the rigid polymeric foam exhibits an open cell or closed cell polymeric foam structure.
